(19) United States
(12) Patent Application Publication
(10) Pub. No.: US 2004/0003686 A1
(43) Pub. Date: Jan. 8, 2004

(54) Tool for tuning a hexagon-head member

(76) Inventor: JacquesRapha?euml;l Cagny, (US)

Correspondence Address: WENDEROTH, LIND & PONACK, L.L.P., 2033 K STREET N. W., SUITE 800, WASHINGTON, DC, 20006-1021, US

(21) Appl. No.: 10/240,670

(22) PCT Filed: Apr. 5, 2001
(86) PCT No.: PCT/FR01/01041

(30) Foreign Application Priority Data
Apr. 7, 2000 (FR) 00/04509

(51) Int. Cl. B25B 13/00

(52) U.S. Cl. 81/186

(57) ABSTRACT

The invention concerns a tool with a rigid jaw (3) defining four protuberances (P1 to P4). The two end protuberances (P1, P4) engage the opposite lobe (41, 42) of the head (4) to be driven, and the intermediate front protuberance (P2) provides a bearing point on the intermediate front lobe (44). The fourth protuberance (P3) serves as repositioning guide The tool enables to turn a TORXprofile with ratcheting and a repositioning of slightly more than 60.

The present invention relates to a tool for turning a threaded member, particularly a screw or a nut, the head of which has a six-lobed male drive profile.

A “six-lobed male profile” is to be understood as meaning a male profile consisting of an alternation of six convex curved lobes and of six concave curves connecting them. An example of such a profile is described in U.S. Pat. No. 3,584,667.

The invention applies in particular to the driving of standard “TORX” profiles.

Known tools with one-piece jaws for “TORX” profiles are essentially wrenches or sockets with a closed female profile which allow only axial access to the male-profile head of the threaded member. It is therefore necessary for them to be cleared axially off the six-lobed head each time the tool is repositioned by 60°.

Also in existence are self-ratcheting or “fast-acting” wrenches that allow the tool to be repositioned without having to clear the jaw off the head. Examples are described in WO-A-97 00 758 (repositioning at 60°) and FR-A-2 760 206 (repositioning at about 30°), both in the name of the Applicant Company. However, these self-ratcheting wrenches are designed to drive hexagon heads and are not suited to the driving of six-lobed heads.

It is an object of the invention to provide a tool for a six-lobed head, allowing access both axially and laterally to such a head and capable of ratcheting while at the same time remaining in contact with this head, and having better performance, from the drive torque point of view, similar to the performance of conventional closed-profile tools designed for the same six-lobed heads.

To this end, the tool according to the invention is characterized by the characterizing part of claim 1.

The tool according to the invention may comprise one or more of the characteristics described in claims 2 to 15, taken in isolation or in any technically feasible combination.

Exemplary embodiments of the invention will now be described with reference to the appended drawings, in which:

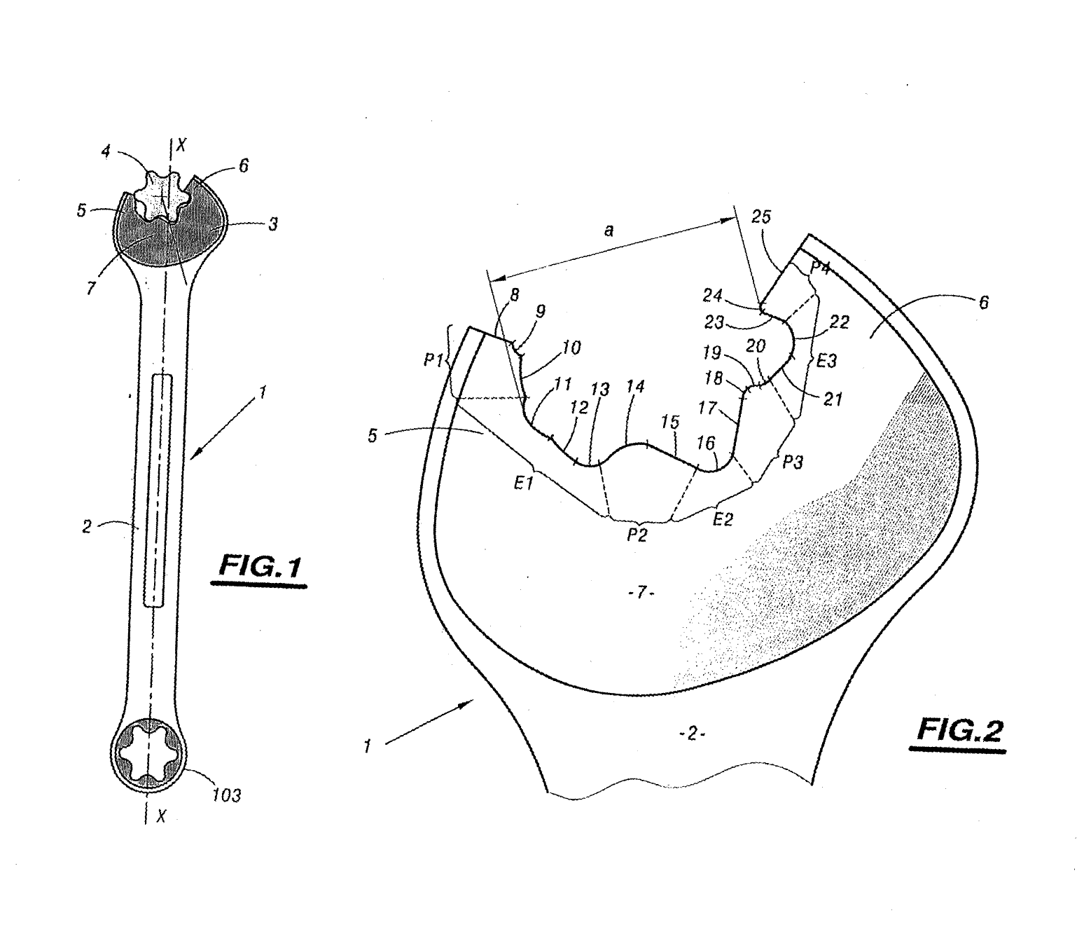

FIG. 1 is an elevation of a self-ratcheting wrench according to the invention, engaged for driving on a six-lobed male head;

FIG. 2 depicts, on a larger scale, the jaw of this wrench;

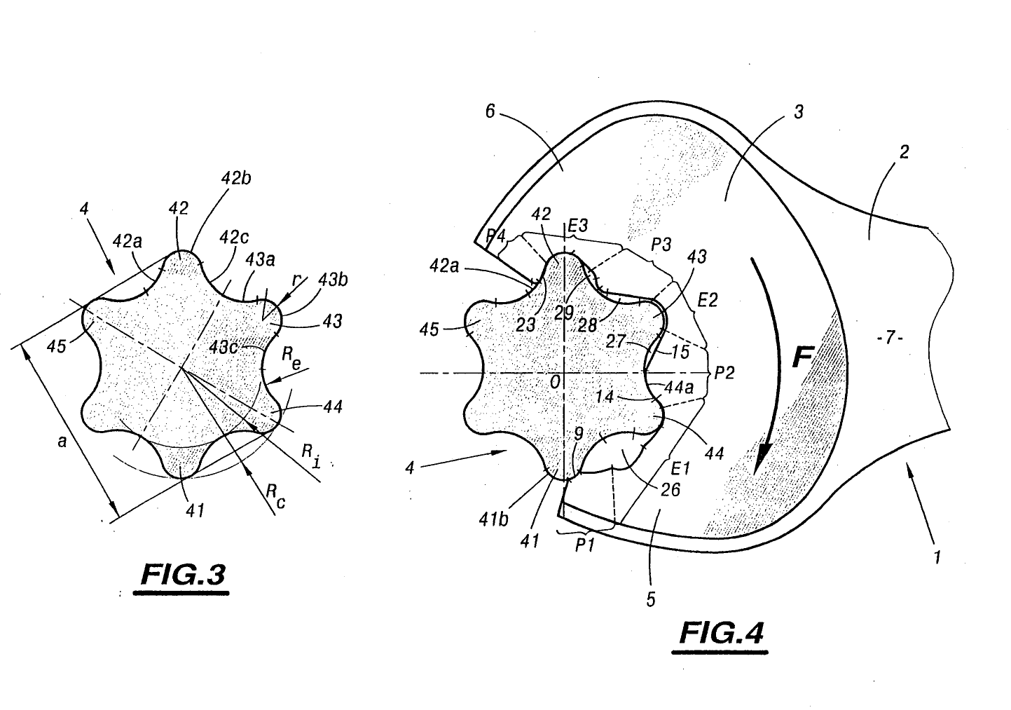

FIG. 3 depicts the six-lobed head on the same scale as FIG. 2;

FIG. 4 depicts the jaw in driving engagement on this head to the same scale;

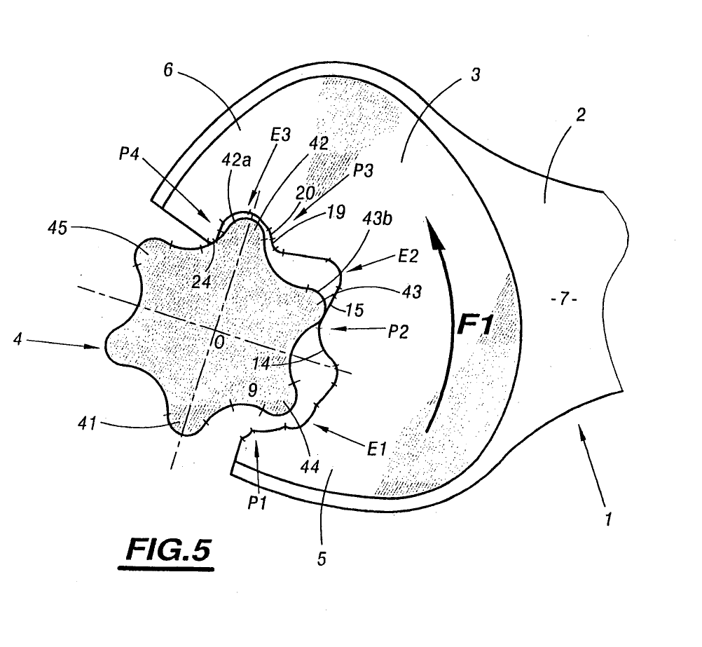

FIGS. 5 to 8 are views similar to FIG. 4 illustrating four successive phases in the repositioning movement;

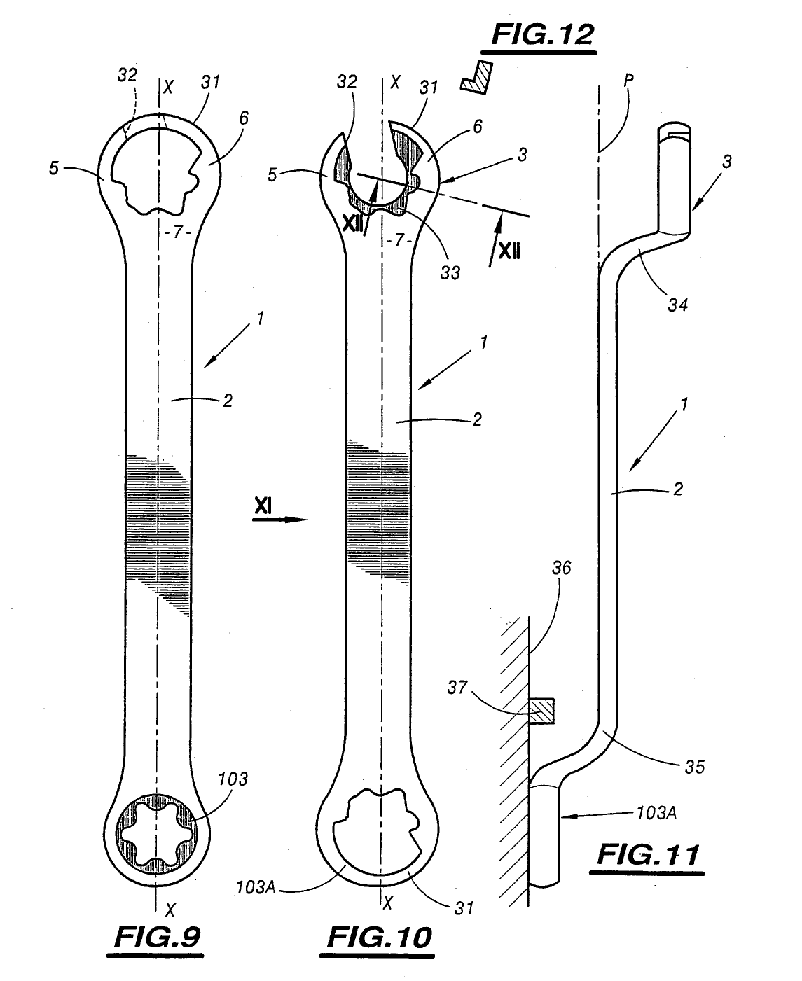

FIG. 9 depicts an alternative form, in plan view;

FIG. 10 depicts a plan view of another alternative form;

FIG. 11 is a side view in the direction of arrow XI of FIG. 10; and

FIG. 12 is a part view taken in section on XII-XII of FIG. 10.

The self-ratcheting wrench 1 depicted in FIG. 1 is a one-piece part made of steel of flat overall shape, comprising a shaft 2 of elongate shape, of overall axis X-X, which broadens at its distal end to form a drive jaw 3. At its other end, the shaft 2 may form another driving head, either similar to the jaw 3 but of a different size, or of any other known type, particularly of the open-ended spanner or ring spanner type, as illustrated at 103.

The jaw 3 is intended to drive clockwise F a six-lobed male head 4, best visible in FIGS. 3 to 8, which will be assumed to be a screw head. In the description which follows, the words “front” and “rear”, “moves forward” and “moves back” refer to this direction of drive.

The jaw 3 may be considered to consist of three regions: a front jaw element 5, a rear jaw element 6 and an intermediate bow 7 connecting these two jaw elements. The interior profile of these three regions will be described hereinbelow.

The jaw element 5 comprises a front protrusion P1.

The jaw element 6 comprises a rear protrusion P4.

The bow 7 comprises two, a front intermediate P2 and a rear intermediate P3, protrusions. A recess E1 separates the protrusion P1 from the protrusion P2, a recess E2 separates the protrusion P2 from the protrusion P3 and a recess E3 separates the protrusion P3 from the protrusion P4.

Thus, from front to rear, the jaw 3 has four successive protrusions P1 to P4 separated by three successive recesses E1 to E3.

A “protrusion” is to be understood as meaning a part of convex overall shape, and a “recess” is to be understood as meaning a part of concave overall shape connecting two successive protrusions.

From front to rear:

P1 consists in succession of a straight-line segment 8, of a concave curve 9 and of a concave rounded portion 10 of large radius;

E1 consists in succession of a first concave curve 11, of a concave rounded portion 12 of large radius and of a second concave curve 13;

P2 consists in succession of a convex curve 14 and of a straight-line segment 15;

E2 consists of a concave rounded portion 16;

P3 consists in succession of a straight-line segment 17, of a convex rounded portion 18 of small radius, of a straight-line segment 19 and of a concave rounded portion 20 of large radius;

E3 consists in succession of a straight-line segment 21 and of a concave curve 22; and

P4 consists in succession of a convex curve 23, of a convex rounded portion 24 of small radius and of a straight-line segment 25.

FIG. 3 depicts the six-lobed profile of the screw head 4, which is of the standard TORX type.

In this example, the profile of the screw head 4 consists of six lobes which are diametrically opposed in pairs and distributed at uniform angular intervals of 60°.

If two diametrically opposed lobes 41 and 42 are considered, these respectively being the lower and upper lobes in FIGS. 3 and 4, these are separated on each side by two other, intermediate, lobes.

Considering the clockwise direction:

the lobe 41 will be considered as being the front lobe;

the lobe 42 will be considered as being the rear lobe;

the lobe 43 will be considered as being the rear intermediate lobe;

the lobe 44 will be considered as being the front intermediate lobe.

Furthermore, the lobe lying immediately to the rear of the rear lobe 42 is referenced 45.

Considering the clockwise direction, each lobe is made up of a front flank and of a rear flank, the front flank of a first lobe connecting directly to the rear flank of the lobe situated immediately in front of the first.

Thus, the front flank of a lobe N consists in succession of a part of a convex arc Nb starting from the vertex of the lobe, and of a concave curve Nc.

Symmetrically, the rear flank of the lobe N consists in succession of the other part of the convex arc Nb starting from the vertex of the lobe and of a concave curve Na.

All the curves of the six-lobed profile meet each other tangentially, which means that the profile has no sharp corners.

The radius of the circle inscribed inside the profile is denoted Ri, that of the circle circumscribing this profile is denoted Rc, the radius of the convex arcs of the lobes is denoted r, the radius of the concave arcs Na and Nc is denoted Re, and the “dimension across flats” of the profile, that is to say the distance separating two tangents to two opposed pairs of lobes, is denoted a. The aforementioned concave curve 9 has the radius r.

FIG. 4 depicts the jaw 3 in engagement for driving in the clockwise direction F with the head 4. In this position, the only contacts between the wrench and the head are between the protrusions P1, P2 and P4 and, respectively, the lobes 41, 44 and 42.

More specifically, when the tool and the head have their nominal dimensions:

the concave curve 9 of P1 hugs the part of the convex arc 41b that is situated on the rear flank of the front lobe 41 and bears against this part over the entire length of the curve 9;

the convex curve 23 of the front flank P4 has the radius Re, hugs the concave curve 42a of the rear flank of the rear lobe 42 and bears against this curve along the entire length of the curve 23;

the convex curve 14 of the front flank of P2 has the radius Re, hugs the concave curve 44a of the rear flank of the front intermediate lobe 44 and bears against this curve along the entire length of the curve 14.

Lateral engagement of the tool over the front 41 and rear 42 lobes of the screw head cannot, however, be direct.

Before arriving at the position depicted in FIG. 4, the tool has first of all to be positioned so that the vertex 24 of the protrusion P4 is in contact with the rear flank of the rear lobe 42 while the vertex 9 of the protrusion P1 is positioned roughly facing the vertex of the intermediate lobe 44.

A movement of turning the tool in the clockwise direction then allows the tool to be placed in its position ready to drive the screw, which position is depicted in FIG. 4.

In spite of this angle of attack, which is about 25°, before positioning the tool, it is very advantageous to have access laterally to the screw, particularly when axial access is very restricted.

Once the tool is in position ready to drive and when a force is applied, for example to the shaft 2, in the direction F, the vectors of the force at the contacts of P1 with the lobe 41 and P4 with the lobe 42 act to form a driving torque on the screw head. The third contact (P2 with the lobe 44) forms both an additional support and a stop for positioning the jaw elements 5 and 6.

In this driving state, it can be seen that:

the rear flank of the protrusion P1 and the recess E1 of the tool form, with the rear flank of the front lobe 41 and the front flank of the front intermediate lobe 44 of the head 4, a wide space 26 in which the tool does not contact the screw head;

the rear flank of the protrusion P2 of the tool, and particularly the straight-line segment 15 forms, with the front flank of the rear intermediate lobe 43 of the head 4, a small space 27 in which the tool does not contact the screw head;

the front flank of the protrusion P3 of the tool and, particularly, the straight-line segment 17 forms, with the rear flank of the rear intermediate lobe 43 of the head 4, a small space 28 in which the tool does not contact the screw head;

the rear flank of the protrusion P3 of the tool and, particularly, the concave curves 19 and 20, forms, with the front flank of the rear lobe 42 of the head 4, a small space 29 in which the tool does not contact the screw head.

In addition, in this same drive position, the protrusion P3 enters the recess separating the lobes 42 and 43, almost as far as being in contact with the bottom of this recess. Thus, the vertex of the protrusion P3 lies a distance slightly greater than Ri from the center O of the head 4.

Other dimensional relationships are satisfied: the distance from the vertex of the rounded portion 24 to the bottom of the curve 11 is at most equal to a (FIG. 2), this rounded portion having the radius r/3. Furthermore, the rounded portions 10 and 12 are centred at the point 0 and have the radius Rc.

Once the tool has driven through a certain rotation, it is backed off in the counterclockwise direction F1 for repositioning, as follows:

The rounded portion 24 of the tool slides along the concave curve 42a of the rear flank of the lobe 42, while the segment 15 of the rear flank of P2 slides along the part of the arc 43b of the front flank of the lobe 43 (FIG. 5). There is no other point of contact between the wrench and the head 4 during this phase.

As the rounded portion 24 continues to progress, the part of the curve 14 adjacent to the segment 15 slides along the arc 43b until the curves 29 then 19 come into contact and slide along the arc 42b.

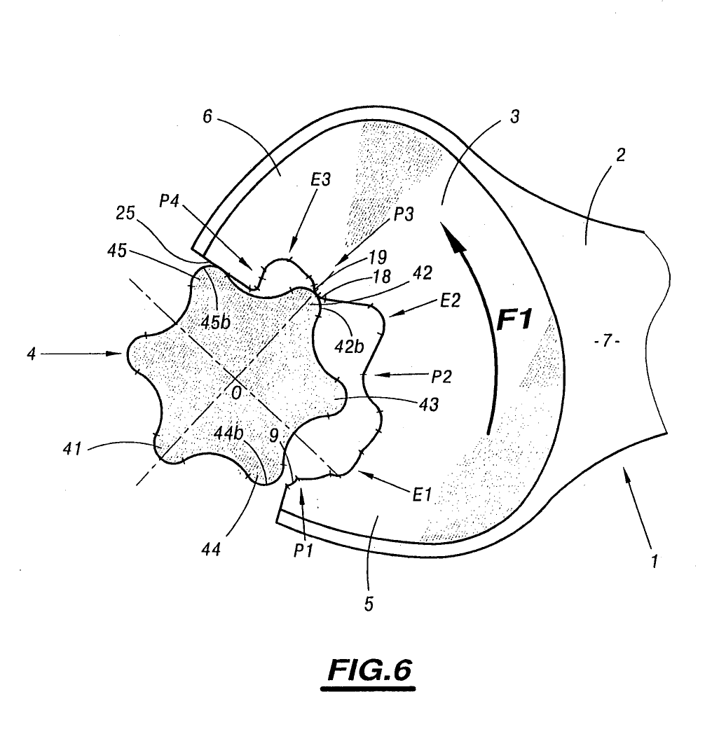

Next, the segment 25 of the tool comes into contact with the arc 45b of the front flank of the lobe 45 and slides on it, while the curves 19 then 18 of the protrusion P3 slide along the vertex 42b of the rear lobe 42 (FIG. 6).

This position is important because it allows the curve 9 to avoid any interference with the vertex 44b of the front intermediate lobe 44.

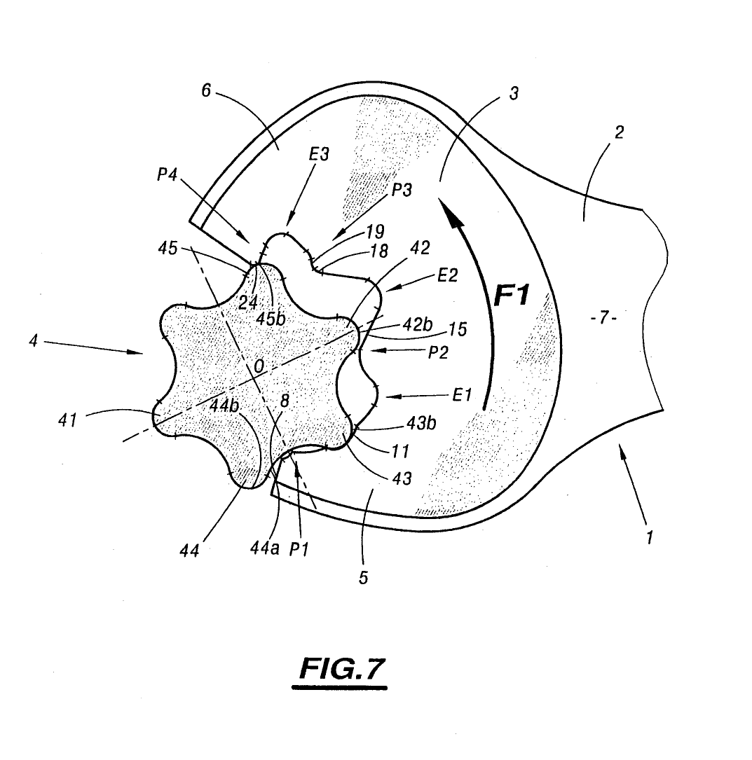

While the segment 25 of the tool continues to slide along the part of the arc 45b of the front flank of the lobe 45, the curve 18 disengages from the arc 42b, the segment 8 of the tool then sliding along the arc 44b of the rear flank of the intermediate lobe 44 then along the curve 44a of the rear flank of this same lobe until the concave curve 11 of the recess E2 comes into contact with the arc 43b of the lobe 43 and until the rounded portion 24 slides along the arc 45b (FIG. 7).

As soon as the segment 15 comes into contact with the arc 42b, the rounded portion 24 leaves the arc 45b, the turning movement of the wrench has to be reversed and the tool has to be driven in the clockwise direction F.

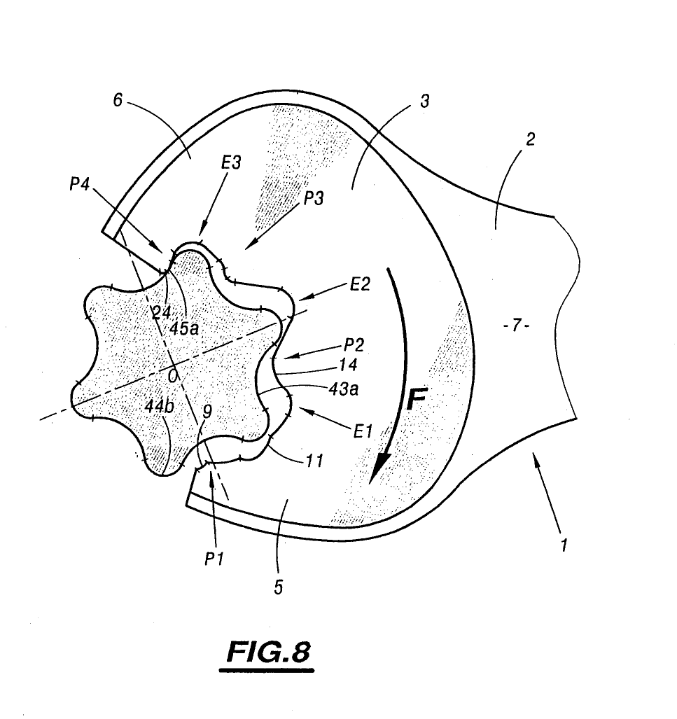

The segment 15 then slides along the arc 42b of the rear lobe 42, the concave curve 11 disengages from the arc 43b of the lobe 43, while the rounded portion 24 slides along the concave curve 45a of the lobe 45 (FIG. 8).

The turning movement in the clockwise direction continues until the concave curve 9 of the protrusion P1 comes into contact with the arc 44b of the lobe 44 and until the convex curve 14 bears against the concave curve 43a of the rear flank of the lobe 43. The tool has now returned to its position of FIG. 4, but retreated angularly by 60° and is ready for a new phase of driving the threaded member.

The new position of the tool with respect to the screw is offset by an angle of 60° with respect to its initial position but it has required an angular movement of the tool slightly in excess of about 65°.

By repeating the forward and backward movements of the tool, a self-ratcheting effect is obtained that allows angular repositioning by 60° on the screw.

The curves of the profile of the tool may be split into three categories:

curves for contact during the driving phases (clockwise direction); these are the portions 9, 14 and 23;

curves for guidance during the repositioning phases (counterclockwise direction); these are the portions 8, 11, 15, 18 to 20, 24 and 25; and

curves connecting the other curves; these are the portions 10, 12, 13, 16, 17, 21 and 22 which are spaced away from the screw head in the absence of torque and across the entire range of torques during driving, and which are also spaced away from this head during the repositioning movements.

The invention applies to a fork-shaped open female tool, particularly to an open-ended spanner as described above, but also applies to a pipe spanner or even to an open socket profile.

However, one alternative form of the invention which is depicted in FIG. 9 can be achieved: by renouncing the possibility of lateral access, it is possible to apply the invention to a female tool of closed profile by supplementing the jaw described above with a stiffening front bow 31, so as to form a ring.

The stiffening bow does not come into contact with the screw head in the drive positions, or during the backward movements of the wrench. If so desired, as indicated in dotted line in FIG. 9, the arc 31 may have an interruption 32 for the passage of a shank or a tube connected to the head 4.

The alternative form in FIGS. 10 and 12 differs from that of FIG. 9 in the following respects:

On the one hand, the front bow 31, interrupted at 32, is strengthened by an insert 33, which is an annular interior collar adjacent a face of the jaw and interrupted, like the bow 31, as known per se.

Furthermore, the shaft is double offset: at one end it has an oblique portion 34 which extends as far as the insert 33, and at the other end it has an oblique portion 35 roughly parallel to the portion 34 and diverging from the overall plane P of the shaft in the opposite direction.

Finally, the second drive head 103A, parallel to the plane P like the jaw 3, is identical to the jaw 3 of FIG. 9, with the continuous bow 31.

The orientation of the protrusions of the head 103A is such that it provides drive in the counterclockwise direction and ratchets in the clockwise direction, in the position of FIG. 11 in which it is applied flat to a surface 36, with the offset 35 avoiding some obstacle 37 that might be protruding from this surface. Having turned the wrench over with respect to the plane P, the jaw 3, on the other hand, becomes driving in the clockwise direction and ratchets in the counterclockwise direction, as described above.

The tool described above has, in its various embodiments, torque transmission performance of roughly 100%, that is to say that it is capable of transmitting practically all of the shear torque of the six-lobed head.

1. A tool for turning a threaded member, particularly a screw or a nut, the head (4) of which has a six-lobed male drive profile, characterized in that it comprises a one-piece jaw (3) delimited by a front jaw element (5) and a rear jaw element (6), when considering the direction of drive (F), which are connected by a connecting bow (7), the jaw elements comprising, respectively, a first protrusion (P1) and a second protrusion (P4) which are designed to collaborate, when the tool is in a driving position, with, respectively, the rear flank of a front lobe (41) and the rear flank of a rear lobe (42) of the drive profile, these two lobes being opposed, the jaw (3) further comprising, on the bow (7), on the one hand a third protrusion (P2) designed to collaborate, in said drive position, in the absence of torque and throughout the range of drive torques applied, with the rear flank of the front intermediate lobe (44) and, on the other hand a fourth protrusion (P3) for guiding during repositioning, which protrudes between the rear lobe (42) and the rear intermediate lobe (43), and in that, when the wrench is in the driving position, there are four spaces between it and said head (4):
a first space (26) between the rear flank of the first protrusion (P1) and that of the front lobe (41);
a second space (27) between the rear flank of the third protrusion (P2) and the front flank of the rear intermediate lobe (43);
a third space (28) between the front flank of the fourth protrusion (P3) and the rear flank of the rear intermediate lobe (43); and
a fourth space (29) between the rear flank of the fourth protrusion (P3) and the front flank of the rear lobe (42),
the protrusions (P1 to P4) and the recesses (E1 to E3) connecting them being dimensioned in such a way as to allow the tool to ratchet with backward movements of the order of 60° while at the same time being pushed constantly toward the axis of the head (4).

2. The tool as claimed in claim 1, characterized in that, in the drive position, when the tool and the head have their nominal dimensions, at least one, and preferably each, of the first (P1), second (P4) and third (P2) protrusions collaborates with the associated lobe (41, 42, 44) via an arc of a curve (9, 23, 14) that is the conjugate of the collaborating part (41b, 42a, 44a) of this lobe.

3. The tool as claimed in claim 2, characterized in that the first protrusion (P1) has, in the region of its vertex, a concave surface (9) for driving contact with the front lobe (41).

4. The tool as claimed in claim 2 or 3, characterized in that the second protrusion (P4) has a convex surface (23) for driving contact with the rear lobe (42).

5. The tool as claimed in any one of claims 2 to 4, characterized in that the third protrusion (P2) has a convex surface (14) for contact with the front intermediate lobe (44).

6. The tool as claimed in any one of claims 1 to 5, characterized in that, in the drive position, the rear intermediate lobe (43) has no point of contact with the wrench.

7. The tool as claimed in any one of claims 1 to 6, characterized in that the third protrusion (P2) has, on its rear flank, a surface (15) for guidance during repositioning, particularly at least partially roughly straight.

8. The tool as claimed in any one of claims 1 to 7, characterized in that the first (P1) and third (P2) protrusions are connected by a recess (E1) which has a surface (11), particularly a concave one, for guiding during repositioning.

9. The tool as claimed in any one of claims 1 to 8, characterized in that the jaw (3) forms an open fork.

10. The tool as claimed in any one of claims 1 to 9, characterized in that the jaw is at least partially closed by a front bow (34) to form a ring, this front bow being shaped in such a way as to avoid any contact with the head (4) in each of the drive positions and during the backward movements of the wrench (1) when this wrench is pushed toward the head along the axis (X-X) of the shaft (2).

11. The tool as claimed in claim 10, characterized in that the front bow (34) has an interruption (134) allowing a shank or a tube connected to said head (4) to pass.

12. The tool as claimed in any one of claims 1 to 11, characterized in that it comprises a shaft (2) bearing the jaw (3) and equipped at its opposite end to this jaw (3) with a second jaw (103A) similar to the first jaw (3) and of the same or different size, or with a drive head of another type, particularly of the open-ended spanner or ring spanner type (103).

13. The tool as claimed in claim 12, characterized in that the second jaw (103A) has the same size as the first jaw (3) but is designed to drive the head (4) in the opposite direction.

14. The tool as claimed in any one of claims 1 to 13, characterized in that it comprises a shaft (2) bearing the jaw and offset (at 34, 35) in the vicinity of one or each jaw (3, 103A), and/or one or each jaw comprises an insert (33) to indicate the direction in which the jaw should be fitted over the head (4).

15. The tool as claimed in any one of claims 1 to 14, characterized in that it constitutes a self-ratcheting wrench or a drive socket.
